(19) United States
(12) Patent Application Publication
(10) Pub. No.: US 2010/0087138 A1
(43) Pub. Date: Apr. 8, 2010

(54) Compact mobile weather device

(76) Inventor: Mark D. Hedstrom, Naples, FL (US)

Correspondence Address: LAW OFFICE OF JERRY D. HAYNES , P.A, P.O. Box 350392, Fort Lauderdale, FL, 33335, US

(21) Appl. No.: 12/285,379

(22) Filed: Oct. 3, 2008

(51) Int. Cl. H04H 20/71

(52) U.S. Cl. 455/3.01

(57) ABSTRACT

The present invention relates to a compact and portable electronic device intended for the purpose of receiving live NOAA weather and special alert radio broadcasts. This compact portable device advantageously re-broadcasts the NOAA audio alert messages via any suitable receiver capable of receiving digital or analog signals. In one exemplary embodiment, an AM/FM radio broadcast band may be used to re-broadcast the received NOAA weather broadcast. The compact electronic device could also be used via a Bluetooth enabled device, which would allow for the reception of weather and special alert audio and/or text messages relaying pertinent weather broadcasts. The present invention also relates to a system for the reception and transmission of weather broadcasts where said system comprises: a mobile device capable of receiving weather broadcasts; a means to convert the received weather broadcast signal to a transmission signal; and a means to receive the transmission signal for annunciation.

### CROSS REFERENCE TO RELATED APPLICATIONS

The present application claims priority to U.S. Provision Application No. 60/997,175 filed on Oct. 2, 2007.

### BACKGROUND OF THE INVENTION

1. Field of the Invention

The present invention relates to a compact National Oceanographic and Atmospheric Administration (NOAA) weather radio with an FM modulator and/or Bluetooth transceiver.

2. Description of Related Art

The present invention relates in general to the NOAA weather radio service which provides broadcast of National Weather Service warnings, watches, forecasts and other hazardous information 24 hours a day via a network of transmitters located throughout the United States. The NOAA radio system provides nationwide service and is a network that includes over 650 broadcasting stations located in 50 states. The information provided through the NOAA weather radio system is valuable to many users. It is particularly valuable to boating enthusiasts who need to know weather conditions prior to setting off to sea. Many boaters themselves employ and include weather radio systems on their boats, however, it would be advantageous to have this information prior to embarking onto one's vessel. Further, many times warnings and alerts are provided for several days of forecasts and therefore a user could use this information prior to planning a weekend getaway. Other users may include pilots, hunters, golfers, fisherman and any outdoor enthusiasts.

Various devices are available for one to periodically check the weather broadcast in a stationary fashion. However, few are available to use existing FM modulation or Bluetooth technology in order to receive the NOAA weather broadcast alerts.

### SUMMARY OF THE INVENTION

The present invention relates to a compact and portable electronic device intended for the purpose of receiving live NOAA weather and special alert radio broadcasts. This compact portable device advantageously re-broadcasts the NOAA audio alert messages via an AM/FM broadcast band which in itself could be a standard fixed or mobile device. The compact electronic device could also be used via a Bluetooth enabled device, which would allow for the reception of weather and special alert audio and/or text messages relaying pertinent weather broadcasts.

The present compact wireless device/receiver includes a series of bypass filters, a tone decoder, a transmitter section, a means for audio transmission, a microcomputer controller, a display means, a channel alert means and a power supply.

In accordance with these and other objects which will become apparent hereinafter, the instant invention will now be described with particular reference to accompanying drawings.

### BRIEF DESCRIPTION OF THE DRAWINGS

FIG. 1 shows a perspective view of the present invention.

FIG. 2 shows a side perspective view of the present invention.

FIG. 3 shows an exemplary block diagram as contemplated by the present invention.

FIG. 4 shows an exemplary system overview of the present invention in one.

### DETAILED DESCRIPTION

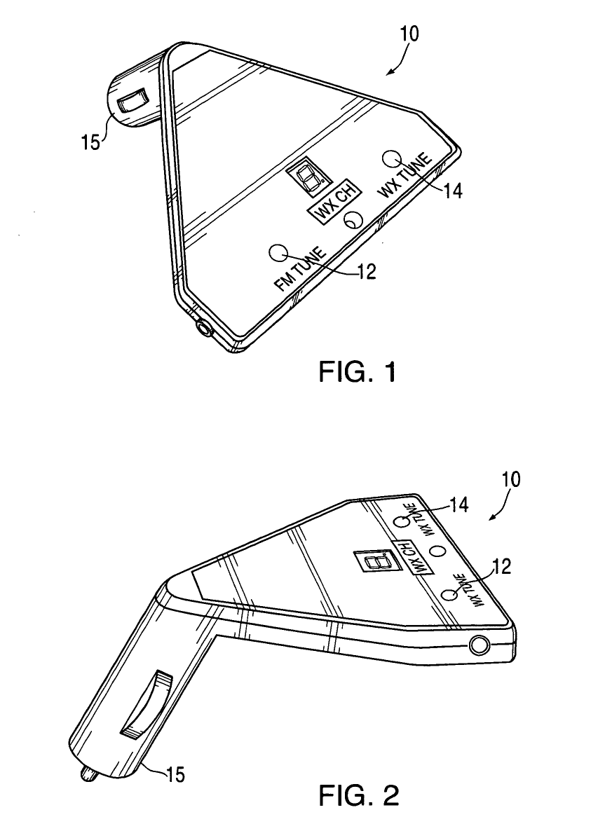

FIG. 1 shows a perspective view of the present invention, a compact NOAA transceiver 10. As shown, the transceiver 10 includes a power supply connection 15 with the transceiver 10 at the opposite end shaped in a manner to receive signals from a NOAA weather broadcast. FIG. 2 shows a side perspective view of the present invention wherein the power supply 15 is clearly shown. Ideally, since this transceiver 10 is portable and compact, one exemplary means of supplying power would be the insertion of the transceiver 10 into a DC power supply such as a cigarette lighter in a conventional automobile or truck. By applying such a means for power supply, the transceiver 10 could be easily used on an FM channel within a vehicle's already equipped radio receiver. The transceiver 10 could be easily used with an adapter to be placed into an AC power supply in someone's home or portable trailer. In one exemplary embodiment, the transceiver 10 is small in size so that it may be readily transported from vehicle to vehicle or from vehicle to inside a home.

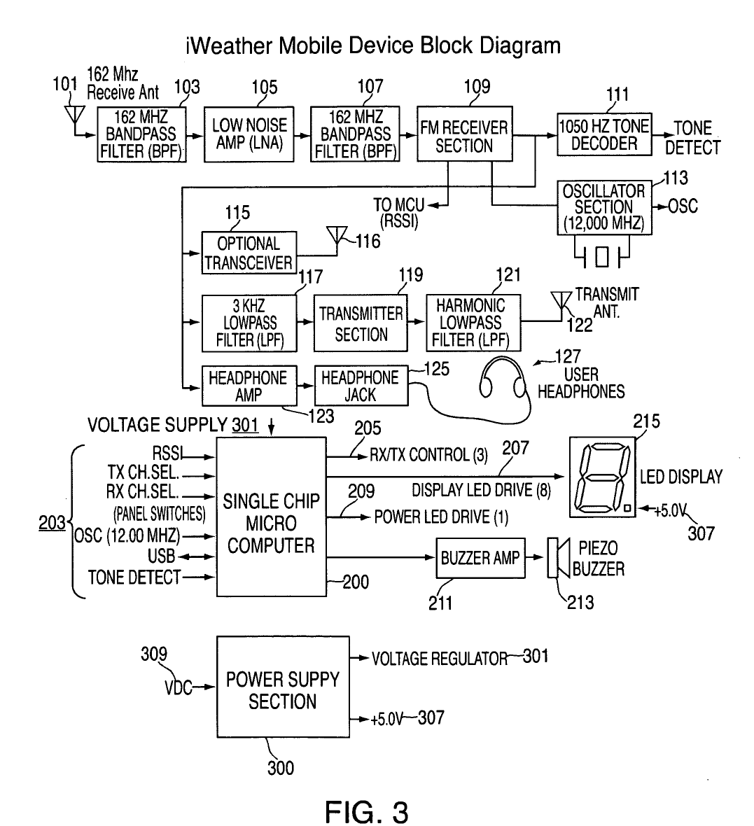

FIG. 3 provides a block diagram of the transceiver. As shown in the block diagram, a receiver antenna 101 is shown. The receiver antenna 101 operates at 162 MHZ in one exemplary embodiment although this frequency may be varied to coincide with available frequencies transmitted by the NOAA. The receiver antenna 101 transmits the received signals from the weather radio broadcast to a 162 MHZ bypass filter 103 which passes the signal through a low noise amplifier 105. A bypass filter 107 receives the signal from the low noise amplifier 105 and then transmits this to the FM receiver 109. The FM receiver 109 is synchronized through a oscillator 113 which connects to a microcomputer 200. The signal strength is constantly monitored by the microcomputer 200 and the FM receiver 109 transmits this signal to a 1,050 HZ tone decoder 111. The block diagram also depicts an optional transceiver 115 which is connected to an antenna 116 for transmission to any Bluetooth equipped device in one exemplary embodiment. Alternatively, the transceiver 115 may be used to transmit to any receiver capable of receiving digital or analog audio. Also the FM receiver transmits to a 3 KHZ low bypass filter 117 which sends the signal to a transmitter section 119. The signal from the transmitter section 119 travels to the harmonic low bypass filter 121 for transmission via a transmission antenna 122. The signal transmitted by the transmission antenna 12 may be received and broadcasted over conventional FM radio or alternatively via a non-conventional FM radio.

The block diagram shows yet another exemplary embodiment wherein the FM receiver section 109 transmits the signal to a headphone amp 123 and onward to a headphone jack 125. This enables the user to listen to received signals via user headphones 127.

In addition to the above signal transmission stream and alternate embodiments disclosed above, the block diagram depicts the single microcomputer 200. This microcomputer 200 includes exemplary inputs 203 that include a transmission channel selection and a receiving channel selection. Further inputs shown include oscillator 113, a USB connection and the tone detect from the tone decoder 111. The microcomputer 200 also includes a receiver transmission control device 205, an LED display 215 which is connected off a display LED drive 207. The display LED 215 receives power via a LED drive 209. This exemplary embodiment allows for display of channel selection and other necessary information such as signal strength and so forth. The microcomputer also includes a buzzer amplifier 211 connected to a piezo buzzer 213.

Also as noted, FIG. 3 includes an exemplary power supply 300. As stated above in one exemplary embodiment, the power supply 300 includes the ability to receive 11 to 16 VDC through line 309 which may be received from a vehicle cigarette lighter socket or a 12 VDC power supply. Consequently, the power is transmitted to the microcomputer via voltage regulator and 301 and to the LED display at line 307.

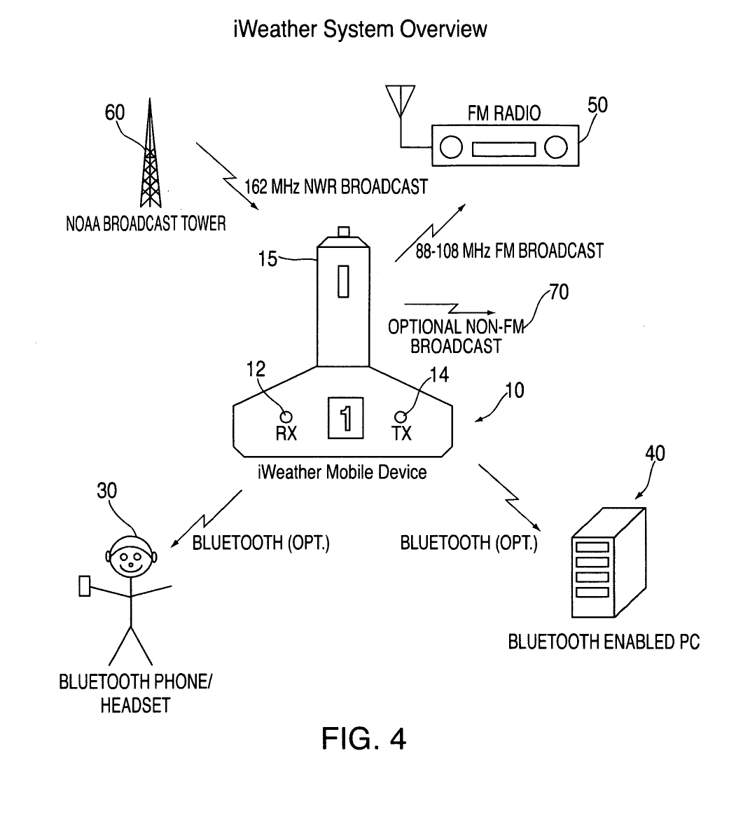

FIG. 4 provides a system overview of the present invention and depicts a couple of exemplary embodiments. The compact transceiver 10 is shown with a receiving antenna 12 and transmission antenna 14. As shown, the transceiver 10 receives the NOAA broadcast signal transmitted by antenna tower 60 via 162 MHZ. The weather broadcast signal received is then transmitted in one exemplary embodiment to an FM radio 50 as shown in FIG. 4. This signal is transmitted at 88 to 108 MHZ in order to be received by the FM radio. Consequently, the FM radio then re-broadcasts this audible signal for the user to hear. A user receives this signal via any available frequency not in use in the broadcast area.

In another exemplary embodiment shown, the transceiver 10 transmits a Bluetooth signal to an individual user via any Bluetooth enabled device. A Bluetooth reception device 30 is shown in one embodiment wherein the Bluetooth device is a phone or possible a PDA capable of receiving a Bluetooth signal. In this exemplary embodiment, the Bluetooth device receives the weather broadcast signal and the user is able to listen via the Bluetooth device 30. In another exemplary embodiment, the transceiver 10 transmits to a Bluetooth enabled PC or stationary device shown as Bluetooth enabled device 40. Bluetooth enabled device 40 in turn receives this weather broadcast signal and produces audio reception for the user. The instant invention has been shown described herein in what is considered to be the most practical and preferred embodiment. It is, however, recognized that departures may be made therefrom within the scope of the invention and obvious modifications may occur to a person skilled in the art.

What is claimed is:

1. A wireless device which receives weather broadcasts and transmits the audio portion for annunciation via a receiver wherein said device comprises:
a. an antenna for the reception of said weather broadcast;
b. a transmitter for transmitting the weather broadcast to the receiver; and
c. a power supply for supplying power to the wireless device.

2. The wireless device according to claim 1, wherein said receiver includes a conventional FM receiver.

3. The wireless device according to claim 2, wherein said FM receiver is a mobile FM receiver.

4. The wireless device according to claim 1, wherein said receiver includes a non-conventional transceiver/receiver.

5. The wireless device according to claim 1, wherein the weather broadcast includes a NOAA weather broadcast.

6. The wireless device according to claim 1, wherein the weather broadcast includes NOAA special alerts.

7. The wireless device according to claim 1, wherein said receiver includes a wired serial device.

8. The wireless device according to claim 8, wherein said wired serial device includes at least one of external headphones and a loudspeaker.

9. The wireless device according to claim 5, wherein said wireless device includes a tone decoder which detects the start of a weather broadcast.

10. The wireless device according to claim 9, wherein said wireless device includes an amplifier and a piezo device to alert user to the start of a weather broadcast.

11. The wireless device according to claim 1, wherein said wireless device includes a display means indicating the weather broadcast channel.

12. The wireless device according to claim 1, wherein said wireless device includes a received signal strength display.

13. A wireless device which receives weather broadcasts and transmits the audio portion for annunciation via a receiver wherein said device comprises:
a. an antenna for the reception of said weather broadcast, wherein said receiver antenna receives signals from the weather broadcast;
b. a means for transmitting the weather broadcast to the receiver; and
c. a power supply for supplying power to the wireless device.

14. The wireless device according to claim 13,-wherein said means for transmitting includes a series of filters capable of converting the received weather broadcast signal to a transmission signal for annunciation.

15. The wireless device according to claim 14, wherein said transmission signal is a FM signal for annunciation on a FM radio.

16. The wireless de vice according to claim 14, wherein said transmission signal is a Bluetooth signal for annunciation on a Bluetooth enabled device.

17. A system for the receipt and transmission of weather broadcasts where said system comprises:
a. a mobile device capable of receiving weather broadcasts, where the mobile device includes a receiving antenna, a transmission antenna and a power supply;
b. a means to convert the received weather broadcast signal to a transmission signal; and
c. a means to receive the transmission signal for annunciation.

18. The system according to claim 17, wherein said weather broadcast is a NOAA weather broadcast.

19. The system according to claim 17, wherein said transmission signal is at least one of a FM signal for transmission via a FM radio and a Bluetooth signal for transmission over Bluetooth enabled device.

20. The system according to claim 18, wherein said mobile device automatically tunes to the NOAA weather broadcast.
